(19) United States
(12) Patent Application Publication
(10) Pub. No.: US 2025/0390728 A1
(43) Pub. Date: Dec. 25, 2025

(54) DEEP LEARNING ACCELERATOR AND DEEP LEARNING ACCELERATION METHOD

(71) Applicant: REALTEK SEMICONDUCTOR CORPORATION, Hsinchu (TW)

(72) Inventor: HSU-TUNG SHIH, Hsinchu (TW)

(21) Appl. No.: 19/202,646

(22) Filed: May 8, 2025

(30) Foreign Application Priority Data
Jun. 25, 2024 (TW) 113123637

(51) Int. Cl. G06N 3/063

(52) U.S. Cl. CPC G06N 3/063

(57) ABSTRACT

A deep learning accelerator includes a controller circuit, a processing elements (PE) array circuit, and a memory access circuit. The controller circuit generates a control signal according to traffic data. The PE array circuit operates a neural network model. A layer computation of the neural network model includes first and second paths, and the PE array circuit selects a path from the first and second paths according to the control signal to execute the layer computation via the selected path. The PE array circuit accesses a memory circuit via the memory access circuit to execute the layer computation. When the layer computation is executed via the first path, the PE array circuit accesses the memory circuit with first bandwidth. When the layer computation is executed via the second path, the PE array circuit accesses the memory circuit with second bandwidth. The first bandwidth is higher than the second bandwidth.

### BACKGROUND OF THE INVENTION

### 1. Field of the Invention

The present disclosure relates to a deep learning accelerator, especially to a deep learning accelerator and a deep learning acceleration method that are able to adaptively select a proper computational path according to a system workload level.

### 2. Description of Related Art

Existing deep learning accelerators operate neural network models under predetermined operating conditions without considering the current system workload level (or busyness level). In the existing approach, to ensure a certain system performance of the overall system, a deep learning accelerator and a corresponding neural network model are designed and configured during the design phase with considering the possible highest workload level of the overall system (i.e., operating under the worst-case scenario). As a result, the deep learning accelerator and the corresponding neural network model may be overdesigned and still lack the capability to adaptively adjust according to the current system workload level.

### SUMMARY OF THE INVENTION

In some aspects, an object of the present disclosure is to, but not limited to, provide a deep learning accelerator and a deep learning acceleration method that are able to adaptively select a proper computational path according to a system workload level, so as to make an improvement to the prior art.

In some aspects, a deep learning accelerator includes a controller circuit, a processing elements array circuit, and a memory access circuit. The controller circuit is configured to generate a control signal according to traffic data. The processing elements array circuit is configured to operate a neural network model, in which a layer computation of the neural network model comprises a first path and a second path, and the processing elements array circuit is further configured to select a corresponding path from the first path and the second path according to the control signal to execute the layer computation via the corresponding path. The processing elements array circuit accesses a memory circuit via the memory access circuit to execute the layer computation. When the processing elements array circuit executes the layer computation via the first path, the processing elements array circuit accesses the memory circuit with first access bandwidth. When the processing elements array circuit executes the layer computation via the second path, the processing elements array circuit accesses the memory circuit with second access bandwidth, and the first access bandwidth is higher than the second access bandwidth.

In some aspects, a deep learning acceleration method includes the following operations: generating a control signal according to traffic data; and accessing, by a processing elements array circuit, a memory circuit according to the control signal to operate a neural network model, in which a layer computation of the neural network model comprises a first path and a second path, and the processing elements array circuit is configured to select a corresponding path from the first path and the second path according to the control signal to execute the layer computation via the corresponding path, when the layer computation is executed via the first path, the processing elements array circuit accesses the memory circuit with first access bandwidth, and when the layer computation is executed via the second path, the processing elements array circuit accesses the memory circuit with second access bandwidth, and the first access bandwidth is higher than the second access bandwidth.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1A illustrates a schematic diagram of a deep learning accelerator according to some embodiments of the present disclosure.

FIG. 1B illustrates a schematic diagram of a deep learning accelerator according to some embodiments of the present disclosure.

FIG. 2 illustrates a schematic diagram of a neural network model operated by the processing elements array circuit in FIG. 1A or FIG. 1B according to some embodiments of the present disclosure.

FIG. 3A illustrates a schematic diagram of the roofline model for path selection in the second stage of FIG. 2 according to some embodiments of the present disclosure.

FIG. 3B illustrates a schematic diagram of the roofline model for path selection in the third stage of FIG. 2 according to some embodiments of the present disclosure.

FIG. 4 illustrates a schematic diagram of a relationship between the number of outstanding requests and access bandwidth according to some embodiments of the present disclosure.

FIG. 5 illustrates a flowchart of a deep learning acceleration method according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

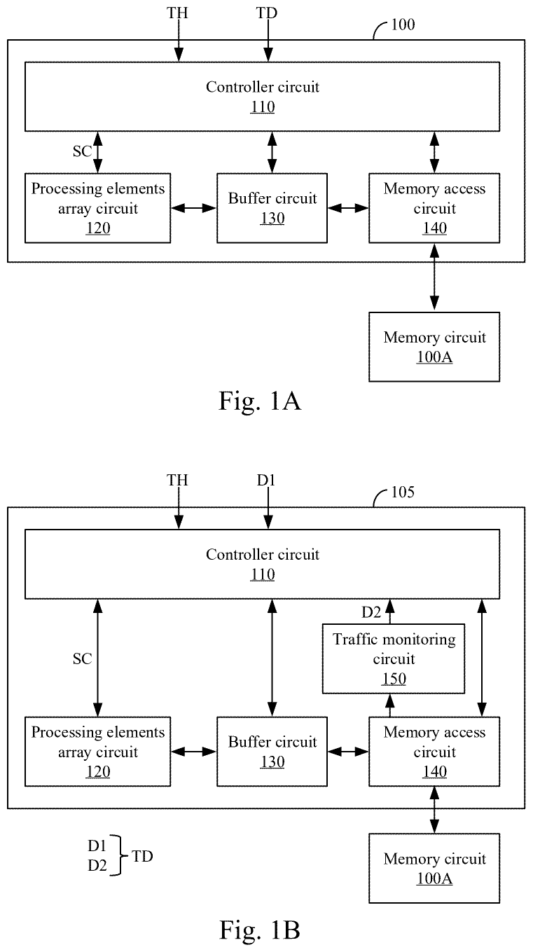

FIG. 1A illustrates a schematic diagram of a deep learning accelerator 100 according to some embodiments of the present disclosure. In some embodiments, the deep learning accelerator 100 may be applicable to applications related to neural network models and/or artificial intelligence models, but the present application is not limited thereto.

The deep learning accelerator 100 includes a controller circuit 110, a processing elements array circuit 120, a buffer circuit 130, and a memory access circuit 140. The controller circuit 110 is configured to generate a control signal SC according to traffic data TD. In some embodiments, the controller circuit 110 may be implemented with a digital control circuit and/or a microprocessor circuit with computing capabilities, but the present application is not limited thereto. In some embodiments, the memory access circuit 140 may be implemented with a direct memory access (DMA) circuit, but the present application is not limited thereto.

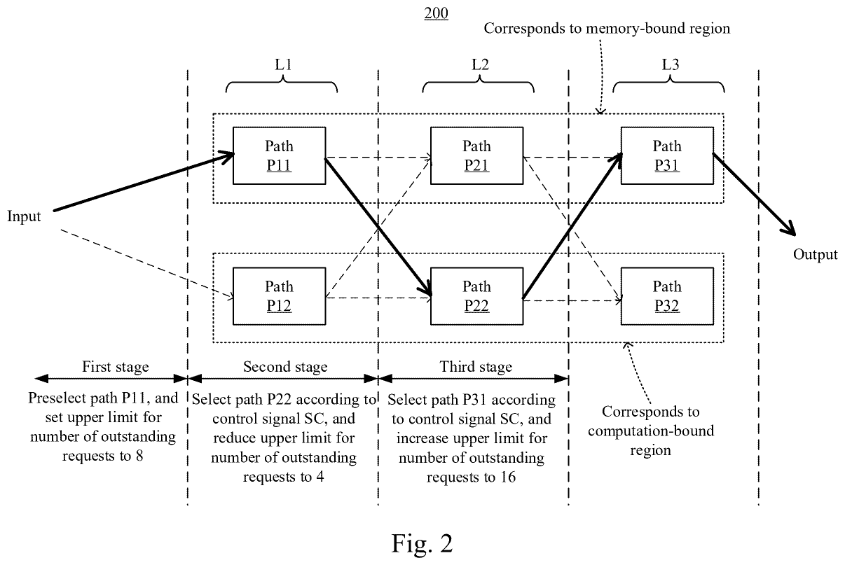

The processing elements array circuit 120 is configured to operate a neural network model to process a task assigned by the controller circuit 110 via the neural network model. In some embodiments, the processing elements array circuit includes processing elements, each of which may include, but is not limited to, computation circuits responsible for various arithmetic and/or logic operations, register circuits for temporarily storing data, control circuits for parsing commands, and other related circuits. The configuration of the aforementioned neural network model will be described later with reference to FIG. 2.

The memory access circuit 140 may receive data required for executing a task from a memory circuit 100A and store this data in batches into the buffer circuit 130. The processing elements array circuit 120 may sequentially read the data from the buffer circuit 130, perform related computations according to the data via the neural network model, and store the obtained computation results into the buffer circuit 130. Accordingly, the memory access circuit 140 may store the computation results stored in the buffer circuit 130 into the memory circuit 100A. In some embodiments, the buffer circuit 130 may be utilized to temporarily store intermediate data generated by the processing elements array circuit 120 during computation. In some embodiments, the buffer circuit 130 may be, but is not limited to, a static random-access memory (SRAM) circuit. In some embodiments, the memory circuit 100A may be a dynamic random-access memory (DRAM) circuit.

In some embodiments, the deep learning accelerator 100 may be integrated with other systems and share the memory circuit 100A with other circuits or modules in the system. In some embodiments, the traffic data TD may be provided by other circuits in the system, such as, but not limited to, a processor or a memory controller of the memory circuit 100A. In some embodiments, the traffic data TD may be utilized to indicate a system workload level (or a system busyness level). For example, if the current available access bandwidth of the memory circuit 100A is too low or the number of outstanding requests is too high, it indicates a higher system workload. Under this condition, the value of the traffic data TD will be higher. Alternatively, if the current available access bandwidth of the memory circuit 100A is higher or the number of outstanding requests is lower, it indicates a lower system workload. Under this condition, the value of the traffic data TD will be lower. The controller circuit 110 may determine the current system workload level according to the traffic data TD (and accordingly predict that the system may have a similar workload level in the near future) and generate a corresponding control signal SC, so that the processing elements array circuit 120 may adjust the computation path used by the neural network model accordingly. The deep learning accelerator 100 may adjust the access bandwidth to the memory circuit 100A and/or the number of requests issued by the deep learning accelerator 100 (or the processing elements array circuit 120) according to the current system workload level, so as to dynamically release resources of the memory circuit 100A for other circuits in the system, thereby improving the overall system performance.

FIG. 1B illustrates a schematic diagram of a deep learning accelerator 105 according to some embodiments of the present disclosure. Compared with the deep learning accelerator 100 in FIG. 1A, in this embodiment, the deep learning accelerator 105 further includes a traffic monitoring circuit 150, and the traffic data TD includes traffic data D1 and traffic data D2. The traffic data D1 is traffic information provided by other circuits in the system (equivalent to the traffic data TD in FIG. 1A). The traffic monitoring circuit 150 is coupled to the memory access circuit 140 and may generate the traffic data D2 according to the data access between the memory access circuit 140 and the memory circuit 100A. The controller circuit 110 may evaluate the system workload level according to the traffic data D1 and the traffic data D2. In some embodiments, the traffic data D2 may be utilized to indicate the access traffic information of the processing elements array circuit 120 to the memory circuit 100A. In some embodiments, the traffic monitoring circuit 150 may only receive the traffic data D2, but the present disclosure is not limited thereto.

In some embodiments, the traffic monitoring circuit 150 may generate the traffic data D2 by measuring the average latency time of the memory access circuit 140 accessing the memory circuit 100A. In some embodiments, the controller circuit 110 may predict the future system workload level according to the traffic data D2 and generate the control signal SC accordingly. Generally, the longer the aforementioned average latency time, the higher the overall system workload. In some embodiments, the implementation of the traffic monitoring circuit 150 may be understood with reference to the traffic scheduling circuitry 120 disclosed in U.S. Patent Publication (US20230396552A1), but the present disclosure is not limited thereto.

FIG. 2 illustrates a schematic diagram of a neural network model 200 operated by the processing elements array circuit 120 in FIG. 1A or FIG. 1B according to some embodiments of the present disclosure. In some embodiments, the neural network model 200 operated by the processing elements array circuit 120 is a multi-branch shared-weights neural network model, which includes multiple layers of computation, with each layer including multiple branch paths.

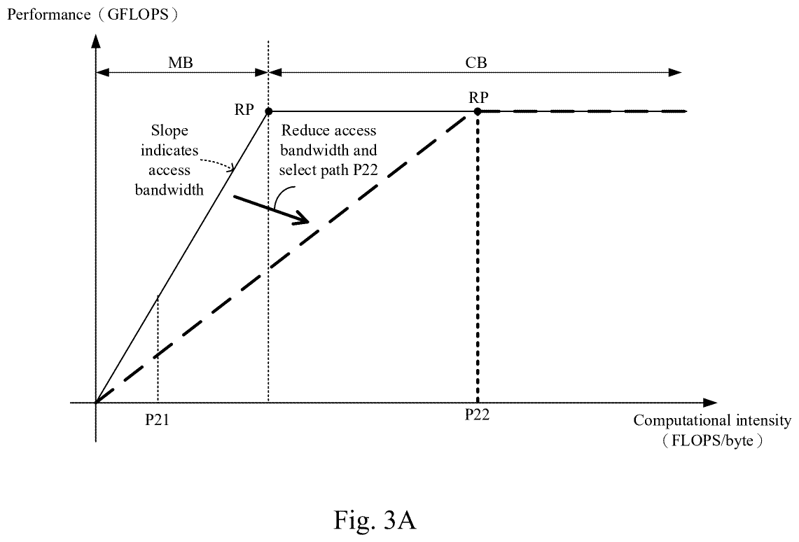

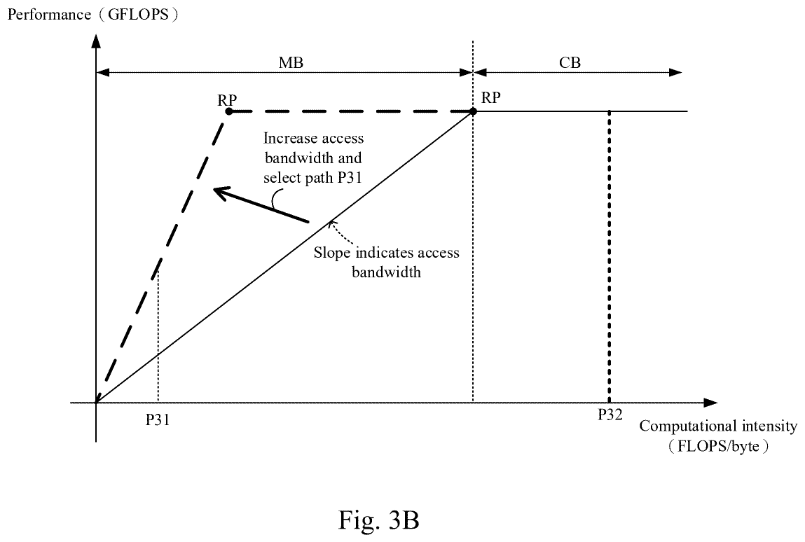

For example, the neural network model 200 includes a first-layer computation L1, a second-layer computation L2, and a third-layer computation L3. In some embodiments, these layer computations may be configured to perform operations related to the neural network model 200, such as, but not limited to, convolution operation(s), floating-point operation(s), matrix multiplication operation(s), activation function operation(s), pooling operation(s), etc. The first-layer computation L1 includes a path P11 and a path P12, the second-layer computation L2 includes a path P21 and a path P22, and the third-layer computation L3 includes a path P31 and a path P32. The processing elements array circuit 120 may select a corresponding path from the first path and the second path according to the control signal SC to execute a corresponding layer computation via the selected path. In some embodiments, the first path (including the path P11, the path P21, and the path P31) corresponds to a memory-bound region in a roofline model, while the second path (including the path P12, the path P22, and the path P32) corresponds to a computation-bound region in the roofline model. Details regarding the roofline model, the memory-bound region, and the computation-bound region will be described later with reference to FIG. 3A and FIG. 3B.

When the processing elements array circuit 120 executes a corresponding layer computation (e.g., the second-layer computation) via the first path (e.g., the path P21), the processing elements array circuit 120 accesses the memory circuit 100A with first access bandwidth. When the processing elements array circuit 120 executes the corresponding layer computation via the second path (e.g., the path P22), the processing elements array circuit 120 accesses the memory circuit 100A with second access bandwidth. In some embodiments, the first access bandwidth is higher than the second access bandwidth. In other words, if the processing elements array circuit 120 selects the path P21 to execute the second-layer computation according to the control signal SC, the processing elements array circuit 120 will access the memory circuit 100A with a higher first access bandwidth. Alternatively, if the processing elements array circuit 120 selects the path P22 to execute the second-layer computation according to the control signal SC, the processing elements array circuit 120 will access the memory circuit 100A with a lower second access bandwidth. In some embodiments, the unit of the “access bandwidth” mentioned herein may be bytes per second (byte/sec), but the present disclosure is not limited thereto.

In greater detail, as shown in FIG. 2, in a first stage, the processing elements array circuit 120 may pre-select the path P11 to execute the first-layer computation L1 according to a predetermined setting. In a second stage, the controller circuit 110 determines that the system workload level indicated by the traffic data TD is greater than a threshold value TH. Under this condition, the controller circuit 110 accordingly outputs a corresponding control signal SC to control the processing elements array circuit 120 to select the path P22 as the corresponding path to execute the second-layer computation L2. As a result, the processing elements array circuit 120 accesses the memory circuit 100A with a lower second access bandwidth and executes the second-layer computation L2, thereby releasing the access bandwidth of the memory circuit 100A for other circuits in the system. In some embodiments, the threshold value TH may be set during an offline design phase and stored in a memory or register (not shown) of the controller circuit 110, but the present application is not limited thereto.

Afterwards, in a third stage, the controller circuit 110 determines that the system workload level, according to the traffic data TD, is not greater than a threshold value TH. Under this condition, the controller circuit 110 accordingly outputs a corresponding control signal SC to control the processing elements array circuit 120 to select the path P31 as the corresponding path to execute the third-layer computation L3. As a result, the processing elements array circuit 120 accesses the memory circuit 100A with a higher first access bandwidth and executes the third-layer computation L3 to enhance computational performance.

In some embodiments, the controller circuit 110 further adjusts the access bandwidth of the processing elements array circuit 120 to the memory circuit 100A according to the traffic data TD. For example, the controller circuit 110 may adjust an upper limit for a number of outstanding requests issued by the processing elements array circuit 120 to the memory circuit 100A via the memory access circuit 140, thereby adjusting the access bandwidth of the processing elements array circuit 120 to the memory circuit 100A. For example, as shown in FIG. 2, in the first stage, the processing elements array circuit 120 may set the upper limit for the number of outstanding requests to 8 according to a predetermined setting. In the second stage, the controller circuit 110 determines that the system workload level, according to the traffic data TD, is greater than the threshold value TH. Under this condition, the controller circuit 110 accordingly outputs the corresponding control signal SC to reduce the upper limit for the number of outstanding requests to 4 (which equals to reducing the access bandwidth of the processing elements array circuit 120 to the memory circuit 100A). In the third stage, the controller circuit 110 determines that the system workload level, according to the traffic data TD, is not greater than the threshold value TH. Under this condition, the controller circuit 110 accordingly outputs the corresponding control signal SC to increase the upper limit for the number of outstanding requests to 16 (which equals to increasing the access bandwidth of the processing elements array circuit 120 to the memory circuit 100A).

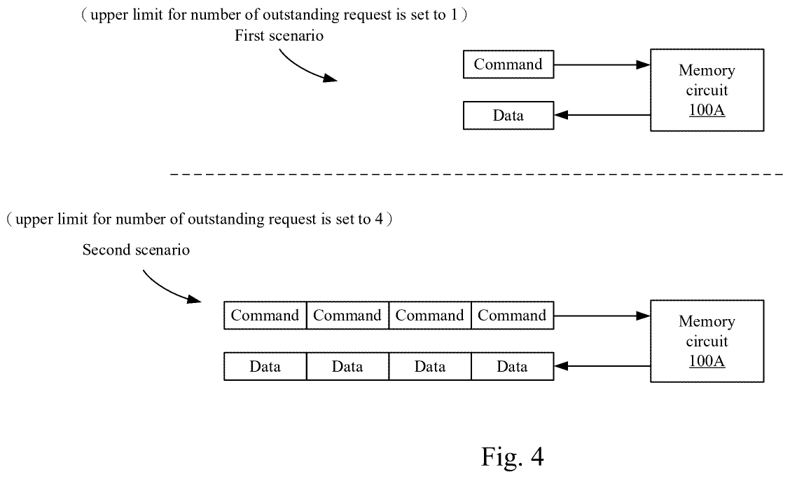

In other words, when the system workload level is too high, the controller circuit 110 restricts the access bandwidth of the processing elements array circuit 120 to the memory circuit 100A, allowing other circuits in the system to utilize the resources of the memory circuit 100A. Alternatively, when the system workload level is not high, the controller circuit 110 relaxes the access bandwidth restriction of the processing elements array circuit 120 to the memory circuit 100A to enhance the computational performance of the processing elements array circuit 120. Details regarding the adjustment of the upper limit for the number of outstanding requests and access bandwidth will be described later with reference to FIG. 4. The numerical values mentioned above are given for illustrative purposes only, and the present disclosure is not limited thereto. For example, in different embodiments, depending on actual application requirements, the number of layers in the multi-layer computation of the neural network model 200 is not limited to 3, and the number of paths in each layer computation is not limited to 2.

FIG. 3A illustrates a schematic diagram of the roofline model for path selection in the second stage of FIG. 2 according to some embodiments of the present disclosure. The roofline model is a performance analysis model that may be employed to analyze the memory access bandwidth requirements of the deep learning accelerator 100 and the impact of memory access bandwidth on computational performance. For example, as shown in FIG. 3A, the vertical axis indicates the achievable performance, measured in giga floating point operations per second (GFLOPS), while the horizontal axis indicates computational intensity, measured in floating point operations per byte of data transfer (denoted as FLOPS/byte). In the roofline model, the area before a ridge point (RP) is a memory-bound region MB, and the area after the ridge point RP is a computation-bound region CB. When the computational intensity of the deep learning accelerator 100 falls within the memory-bound region MB, the performance of the deep learning accelerator 100 is primarily limited by the access bandwidth of the memory circuit 100A (corresponding to the slope of the line segment in the memory-bound region MB). In other words, computations performed in the memory-bound region MB have a high demand for data exchange (including read and write operations) with the memory circuit 100A, which makes the operating speed and access bandwidth of the memory circuit 100A the performance bottleneck of the overall system under this condition. When the computational intensity of the deep learning accelerator 100 falls within the computation-bound region CB, the performance is primarily limited by the computational capability of the processing elements array circuit 120 and/or the system processor. In other words, computations performed in the computation-bound region CB are compute-intensive and have relatively low memory access demands, which makes the computational speed of the processing elements array circuit 120 and/or the system processor the performance bottleneck of the overall system under this condition.

Reference is made to both FIG. 2 and FIG. 3A, as previously mentioned, the first path (including the paths P11, P21, and P31 in FIG. 2) corresponds to the memory-bound region MB, while the second path (including the paths P12, P22, and P32 in FIG. 2) corresponds to the computation-bound region CB. In the second stage, the controller circuit 110 determines that the system workload level, according to the traffic data TD, is higher than the threshold value TH, and thus selects the path P22 to execute the second-layer computation L2 and reduces the access bandwidth of the processing elements array circuit 120 to the memory circuit 100A. With the above operations, as shown in FIG. 3A, the slope of the line segment in the memory-bound region MB is reduced (as indicated by the dashed line segment), thereby adjusting the ridge point RP to a location corresponding to the computational intensity of the path P22. Under this condition, the deep learning accelerator 100 may execute the second-layer computation L2 with a higher computational intensity while releasing the access bandwidth of the memory circuit 100A for other circuits in the system.

As mentioned above, the paths P11, P21, and P31 in FIG. 2 correspond to the memory-bound region MB. In other words, the computations (or algorithms) associated with the paths P11, P21, and P31 have a higher demand for data exchange with the memory circuit 100A. For example, assuming that each input contains 10 data and that a single computation corresponding to the path P21 can process all 10 data in one operation, the processing elements array circuit 120 can request the next set of inputs (i.e., the next 10 data) from the memory circuit 100A immediately for subsequent processing after completing one computation. Thus, if the memory circuit 100A has sufficient access bandwidth, the path P21 can quickly retrieve the required input data and perform continuous related computations. On the other hand, the paths P12, P22, and P32 in FIG. 2 correspond to the computation-bound region CB. In other words, the computations (or algorithms) associated with paths P12, P22, and P32 are compute-intensive. For example, assuming that each input contains 10 data and that the computation corresponding to the path P22 requires multiple reuses of these 10 data, the processing elements array circuit 120 will need to reuse the same 10 data multiple times before requesting a new batch of input data. Under this condition, even if the memory circuit 100A provides a new batch of 10 data during the process, the processing elements array circuit 120 must complete processing the original 10 data before proceeding with the newly received data. As a result, the first path has a higher access bandwidth requirement to the memory circuit 100A compared with the second path. In some embodiments, the computations (or algorithms) corresponding to the paths P11, P21, and P31 in the memory-bound region MB may include, but are not limited to, fully connected (FC) layer computations, depth-wise convolution, or convolution operations with fewer channels. In some embodiments, the computations (or algorithms) correspond to the paths P12, P22, and P32 in the computation-bound region CB may include, but are not limited to, convolution operations with a higher number of channels. In some embodiments, the number of channels in the convolution operation is related to the number of processing elements in the processing elements array circuit 120. For example, if the number of processing elements is high, the convolution operation corresponding to the computation-bound region will also have a higher number of channels. Alternatively, if the number of processing elements is low, the convolution operation corresponding to the computation-bound region will have a lower number of channels.

Accordingly, it is able to understand that there are computational (or algorithmic) differences between the paths P11, P21, and P31, which correspond to the memory-bound region MB, and the paths P12, P22, and P32, which correspond to the computation-bound region CB. The specific algorithms and configurations of these paths may be adjusted according to application requirements and are able to be understood by those skilled in the art; therefore, further elaboration is not given here.

FIG. 3B illustrates a schematic diagram of the roofline model for path selection in the third stage of FIG. 2 according to some embodiments of the present disclosure. As mentioned above, in the third stage, the controller circuit 110 determines that the system workload level, according to the traffic data TD, is not greater than the threshold value TH. As a result, the controller circuit 110 selects the path P31 to execute the third-layer computation L3 and increases the access bandwidth of the processing elements array circuit 120 to the memory circuit 100A. With the above operation, the slope of the line segment in the memory-bound region MB increases (as indicated by the dashed line segment), thereby adjusting the ridge point to the computational intensity corresponding to the path P31. Under this condition, the deep learning accelerator 100 can execute the third-layer computation L3 with a lower computational intensity and a higher access bandwidth (equal to the aforementioned first access bandwidth).

Based on FIG. 3A and FIG. 3B, it is understood that the controller circuit 110 is able to dynamically adjust the computation path used by the processing elements array circuit 120 according to the system workload level indicated by the traffic data TD, in order to allow the deep learning accelerator 100 to achieve the highest performance with the minimum computational intensity (which equals to operating at the ridge point RP) while executing each layer computation, thereby improving the overall system performance and computational efficiency.

FIG. 4 illustrates a schematic diagram of a relationship between the number of outstanding requests and access bandwidth according to some embodiments of the present disclosure. As mentioned above, the controller circuit 110 may adjust the access bandwidth of the processing elements array circuit 120 to the memory circuit 100A by adjusting the upper limit for the number of requests issued by the processing elements array circuit 120 to the memory circuit 100A.

As shown in FIG. 4, in a first scenario, the upper limit for the number of outstanding requests is set to 1. Under this condition, the controller of the memory circuit 100A (not shown) may only process a single command issued by the processing elements array circuit 120. If this command requests to read 1 kilobyte (KB) of data from the memory circuit 100A, where the data burst size of the memory circuit 100A is 256 bytes, and the latency per burst (from issuing the command to retrieving the corresponding burst of data) is approximately 1000 nanoseconds (ns), then the total time required to obtain the 1 KB of data would be approximately 4000 ns (i.e., 4*1000 ns). Under this condition, the estimated access bandwidth of the processing elements array circuit 120 to the memory circuit 100A is approximately 0.25 gigabytes per second (GB/s) (i.e., 1 KB/4000 ns).

In a second scenario, the upper limit for the number of outstanding requests is set to 4. Under this condition, the controller of the memory circuit 100A (not shown) may process four commands issued by the processing elements array circuit 120 in parallel. As a result, the time required to retrieve the 1 KB of data is reduced to approximately 1000 ns. Under this condition, the estimated access bandwidth of the processing elements array circuit 120 to the memory circuit 100A is approximately 1 GB/s (i.e., 1 KB/1000 ns). Accordingly, it is understood that the controller circuit 110 may adjust the access bandwidth of the processing elements array circuit 120 to the memory circuit 100A by adjusting the upper limit for the number of outstanding requests issued by the processing elements array circuit 120 to the memory circuit 100A.

The above adjustments of access bandwidth by adjusting the upper limit for the number of outstanding requests are given for illustrative purposes, and the present disclosure is not limited thereto. Various adjustments to adjust access bandwidth are within the contemplated scope of the present disclosure. For example, in some embodiments, the controller circuit 110 may issue a request to adjust the priority of commands to the arbiter of the memory circuit 100A according to the traffic data TD, in order to adjust the priority order of these commands, and thus adjust the access bandwidth accordingly.

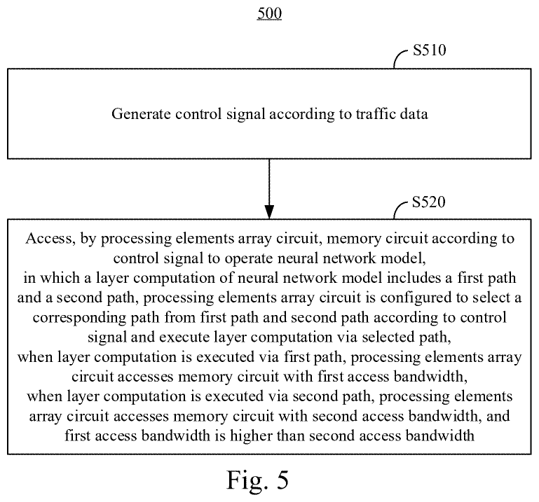

FIG. 5 illustrates a flowchart of a deep learning acceleration method 500 according to some embodiments of the present disclosure. In operation S510, a control signal is generated according to traffic data. In operation S520, a memory circuit is accessed by a processing elements array circuit according to the control signal to operate a neural network model, in which a layer computation of the neural network model includes a first path and a second path, the processing elements array circuit is configured to select a corresponding path from the first path and the second path according to the control signal and execute the layer computation via the selected path, when the layer computation is executed via the first path, the processing elements array circuit accesses the memory circuit with first access bandwidth, when the layer computation is executed via the second path, the processing elements array circuit accesses the memory circuit with second access bandwidth, and the first access bandwidth is higher than the second access bandwidth.

Related implementations about the deep learning acceleration method 500 can be understood with reference to the above embodiments, and thus the repetitious descriptions are not further given. Operations in the deep learning acceleration method 500 may include exemplary operations, but the operations in the deep learning acceleration method 500 are not necessarily performed in the order described above. The operations in the deep learning acceleration method 500 may be added, replaced, changed order, and/or eliminated, or one or more operations in the deep learning acceleration method 500 may be executed simultaneously or partially simultaneously as appropriate, in accordance with the spirit and scope of various embodiments of the present disclosure.

As described above, the deep learning accelerator and deep learning method provided in some embodiments of the present disclosure may dynamically adjust the computation path used by the neural network model according to the system workload level, thereby enhancing overall system performance.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

What is claimed is:

1. A deep learning accelerator, comprising:
a controller circuit configured to generate a control signal according to traffic data;
a processing elements array circuit configured to operate a neural network model, wherein a layer computation of the neural network model comprises a first path and a second path, and the processing elements array circuit is further configured to select a corresponding path from the first path and the second path according to the control signal to execute the layer computation via the corresponding path; and
a memory access circuit,
wherein the processing elements array circuit accesses a memory circuit via the memory access circuit to execute the layer computation,
when the processing elements array circuit executes the layer computation via the first path, the processing elements array circuit accesses the memory circuit with first access bandwidth, and
when the processing elements array circuit executes the layer computation via the second path, the processing elements array circuit accesses the memory circuit with second access bandwidth, and the first access bandwidth is higher than the second access bandwidth.

2. The deep learning accelerator of claim 1, wherein the first path corresponds to a memory-bound region in a roofline model, and the second path corresponds to a computation-bound region in the roofline model.

3. The deep learning accelerator of claim 1, wherein the traffic data is configured to indicate a system workload level, and when the system workload level is greater than a threshold value, the controller circuit outputs the control signal to control the processing elements array circuit to select the second path as the corresponding path.

4. The deep learning accelerator of claim 3, wherein when the system workload level is greater than the threshold value, the controller circuit is further configured to reduce access bandwidth of the processing elements array circuit to the memory circuit.

5. The deep learning accelerator of claim 1, wherein the traffic data is configured to indicate a system workload level, and when the system workload level is not greater than a threshold value, the controller circuit outputs the control signal to control the processing elements array circuit to select the first path as the corresponding path.

6. The deep learning accelerator of claim 5, wherein when the system workload level is not greater than the threshold value, the controller circuit is further configured to increase access bandwidth of the processing elements array circuit to the memory circuit.

7. The deep learning accelerator of claim 1, further comprising:
a traffic monitoring circuit configured to generate the traffic data according to data access between the memory access circuit and the memory circuit.

8. The deep learning accelerator of claim 1, wherein the controller circuit is further configured to adjust access bandwidth of the processing elements array circuit to the memory circuit according to the traffic data.

9. The deep learning accelerator of claim 8, wherein the controller circuit is further configured to adjust an upper limit for a number of outstanding requests issued by the processing elements array circuit to the memory circuit according to the traffic data, in order to adjust the access bandwidth.

10. The deep learning accelerator of claim 1, wherein access bandwidth of the first path to the memory circuit is higher than access bandwidth of the second path to the memory circuit.

11. A deep learning acceleration method, comprising:
generating a control signal according to traffic data; and
accessing, by a processing elements array circuit, a memory circuit according to the control signal to operate a neural network model,
wherein a layer computation of the neural network model comprises a first path and a second path, and the processing elements array circuit is configured to select a corresponding path from the first path and the second path according to the control signal to execute the layer computation via the corresponding path,
when the layer computation is executed via the first path, the processing elements array circuit accesses the memory circuit with first access bandwidth, and
when the layer computation is executed via the second path, the processing elements array circuit accesses the memory circuit with second access bandwidth, and the first access bandwidth is higher than the second access bandwidth.

12. The deep learning acceleration method of claim 11, wherein the first path corresponds to a memory-bound region in a roofline model, and the second path corresponds to a computation-bound region in the roofline model.

13. The deep learning acceleration method of claim 11, wherein the traffic data is configured to indicate a system workload level, and accessing the memory circuit via the processing elements array circuit according to the control signal to operate the neural network model comprises:
selecting, by the processing elements array circuit, the second path as the corresponding path according to the control signal when the system workload level is greater than a threshold value.

14. The deep learning acceleration method of claim 13, further comprising:
reducing access bandwidth of the processing elements array circuit to the memory circuit when the system workload level is greater than the threshold value.

15. The deep learning acceleration method of claim 11, wherein the traffic data is configured to indicate a system workload level, and accessing the memory circuit via the processing elements array circuit according to the control signal to operate the neural network model comprises:
selecting, by the processing elements array circuit, the first path as the corresponding path according to the control signal when the system workload level is not greater than a threshold value.

16. The deep learning acceleration method of claim 15, further comprising:
increasing access bandwidth of the processing elements array circuit to the memory circuit when the system workload level is not greater than the threshold value.

17. The deep learning acceleration method of claim 11, further comprising:
generating, by a traffic monitoring circuit, the traffic data according to data access between a memory access circuit and the memory circuit.

18. The deep learning acceleration method of claim 11, further comprising:
adjusting access bandwidth of the processing elements array circuit to the memory circuit according to the traffic data.

19. The deep learning acceleration method of claim 18, wherein adjusting the access bandwidth of the processing elements array circuit to the memory circuit according to the traffic data comprises:
adjusting an upper limit for a number of outstanding requests issued by the processing elements array circuit to the memory circuit according to the traffic data, in order to adjust the access bandwidth.

20. The deep learning acceleration method of claim 11, wherein access bandwidth of the first path to the memory circuit is higher than access bandwidth of the second path to the memory circuit.
